(19) United States
(12) Patent Application Publication
(10) Pub. No.: US 2024/0151566 A1
(43) Pub. Date: May 9, 2024

(54) Physical Quantity Detection Device, Signal Processing Device, and Signal Processing Method

(71) Applicant: Hitachi Astemo, Ltd., Hitachinaka-shi, Ibaraki (JP)

(72) Inventors: Ryosuke DOI, Hitachinaka-shi, Ibaraki (JP); Masahiro MATSUMOTO, Hitachinaka-shi, Ibaraki (JP)

(21) Appl. No.: 18/281,796

(22) PCT Filed: Feb. 10, 2022
(86) PCT No.: PCT/JP2022/005435

§ 371 Date: Sep. 13, 2023

(30) Foreign Application Priority Data
Apr. 27, 2021 (JP) 2021-074876

(51) Int. Cl. G01F 1/696; G01F 1/72

(52) U.S. Cl. CPC G01F 1/6965; G01F 1/72

(57) ABSTRACT

The present disclosure provides a physical quantity detection device and a signal processing device capable of improving accuracy in detecting an air flow rate by a thermal flow sensor during pulsation of air including a reverse flow region. The signal processing device 200 includes a direction determination unit 210, an increase/decrease determination unit 220, a correction factor storage unit 230, a correction factor selection unit 240, and a signal correction unit 250. The direction determination unit 210 determines a forward flow or a reverse flow of the air based on a detection signal DS of the thermal flow sensor. The increase/decrease determination unit 220 determines an increase or decrease in flow rate of the air based on the detection signal DS. The correction factor storage unit 230 stores first to fourth factors used for correction of the detection signal DS. The correction factor selection unit 240 selects any one of the first to fourth factors as a correction factor CF based on determination results of the direction determination unit 210 and the increase/decrease determination unit 220. The signal correction unit 250 corrects the detection signal DS by using the correction factor CF. The correction factor selection unit 240 selects the first factor in a case of the forward flow of the air and the increase in flow rate, selects the second factor in a case of the reverse flow and the increase in flow rate, selects the third factor in a case of the forward flow and the decrease in flow rate, and selects the fourth factor in a case of the reverse flow and the decrease in flow rate.

### TECHNICAL FIELD

The present disclosure relates to a physical quantity detection device, a signal processing device, and a signal processing method.

### BACKGROUND ART

Hitherto, a thermal air flowmeter suitable for detecting a flow rate of air sucked into an engine of an automobile is known. Examples of such a thermal air flowmeter include a heating resistor, a heating drive circuit, and a temperature-sensitive resistor (PTL 1, Abstract, claim 1, or the like).

The heating resistor heats a fluid. The heating drive circuit causes a current to flow through the heating resistor to control heating of the heating resistor. The temperature-sensitive resistor is disposed upstream and downstream of the heating resistor and detects the temperature of the fluid heated by the heating resistor. The thermal air flowmeter detects a flow rate of the fluid based on a temperature difference between the upstream side and the downstream side of the temperature-sensitive resistor.

The thermal air flowmeter described in PTL 1 further includes flow rate correction amount calculation means and flow rate correction means (claim 1 or the like). The flow rate correction amount calculation means calculates a flow rate correction amount based on a change amount of a detected flow rate and a flow rate correction factor set according to the detected flow rate. The flow rate correction means corrects the detected flow rate based on the flow rate correction amount.

With the thermal air flowmeter according to the related art, the air flow rate can be accurately detected even in a case of an engine system with a large air pulsation. In addition, it is possible to obtain a flow rate with high responsiveness and little distortion of a detection waveform without impairing reliability of a detection element (paragraph 0014, PTL 1).

### CITATION LIST

### Patent Literature

PTL 1: JP 2010-261750 A

### SUMMARY OF INVENTION

### Technical Problem

For example, when a variable valve mechanism is employed in an engine of an automobile, pulsation of intake air including a reverse flow region is likely to occur in a case of air sucked into the engine. Although the thermal air flowmeter according to the related art can achieve the excellent effect as described above, there is room for improvement in accuracy in detecting an air flow rate during pulsation of air including a reverse flow region in which an air flow direction repeatedly changes from a forward flow to a reverse flow and from the reverse flow to the forward flow.

The present disclosure provides a physical quantity detection device, a signal processing device, and a signal processing method capable of improving accuracy in detecting an air flow rate by a thermal flow sensor during pulsation of air including a reverse flow region.

### Solution to Problem

One aspect of the present disclosure is a physical quantity detection device including: a thermal flow sensor that is configured to detect a forward flow and a reverse flow of air; and a signal processing device that processes a detection signal of the thermal flow sensor, in which the signal processing device includes a direction determination unit that determines the forward flow or the reverse flow of the air based on the detection signal, an increase/decrease determination unit that determines an increase or decrease in flow rate of the air based on the detection signal, a correction factor storage unit that stores a first factor, a second factor, a third factor, and a fourth factor used for correction of the detection signal, a correction factor selection unit that selects, as a correction factor, the first factor, the second factor, the third factor, or the fourth factor based on determination results of the direction determination unit and the increase/decrease determination unit, and a signal correction unit that corrects the detection signal by using the correction factor, and the correction factor selection unit selects the first factor in a case of the forward flow and the increase in flow rate, selects the second factor in a case of the reverse flow and the increase in flow rate, selects the third factor in a case of the forward flow and the decrease in flow rate, and selects the fourth factor in a case of the reverse flow and the decrease in flow rate.

### Advantageous Effects of Invention

According to the above-described aspect of the present disclosure, it is possible to provide a physical quantity detection device, a signal processing device, and a signal processing method capable of improving accuracy in detecting an air flow rate by a thermal flow sensor during pulsation of air including a reverse flow region.

### BRIEF DESCRIPTION OF DRAWINGS

FIG. 1 is a system view illustrating an embodiment of a physical quantity detection device and a signal processing device according to the present disclosure.

FIG. 2 is a rear view of the physical quantity detection device provided in a main passage of an engine system of FIG. 1.

FIG. 3 is a left side view of the physical quantity detection device of FIG. 2.

FIG. 4 is a right side view of the physical quantity detection device of FIG. 2.

FIG. 5 is a rear view illustrating a state in which a cover of the physical quantity detection device of FIG. 2 is removed.

FIG. 6 is a cross-sectional view of the physical quantity detection device taken along line VI-VI of FIG. 5.

FIG. 7 is an enlarged schematic plan view of a thermal flow sensor of the physical quantity detection device of FIG. 6.

FIG. 8 is a functional block diagram of the signal processing device that processes a detection signal of the thermal flow sensor of FIG. 6.

FIG. 9 is a block diagram illustrating a flow of signal processing in the signal processing device of FIG. 8.

FIG. 10 is a graph illustrating an example of a relationship between a difference ΔS and a detection signal DS illustrated in FIG. 9.

FIG. 11 is a graph of a flow rate waveform with a vertical axis representing a flow rate of air and a horizontal axis representing time.

FIG. 12 is a block diagram illustrating a first modified example of the physical quantity detection device and the signal processing device.

FIG. 13 is a block diagram illustrating a second modified example of the physical quantity detection device and the signal processing device.

FIG. 14 is a graph of a flow rate waveform with a vertical axis representing a flow rate of air and a horizontal axis representing time.

FIG. 15 is a block diagram illustrating a third modified example of the physical quantity detection device and the signal processing device.

### DESCRIPTION OF EMBODIMENTS

Hereinafter, an embodiment of a physical quantity detection device, a signal processing device, and a signal processing method according to the present disclosure will be described with reference to the drawings.

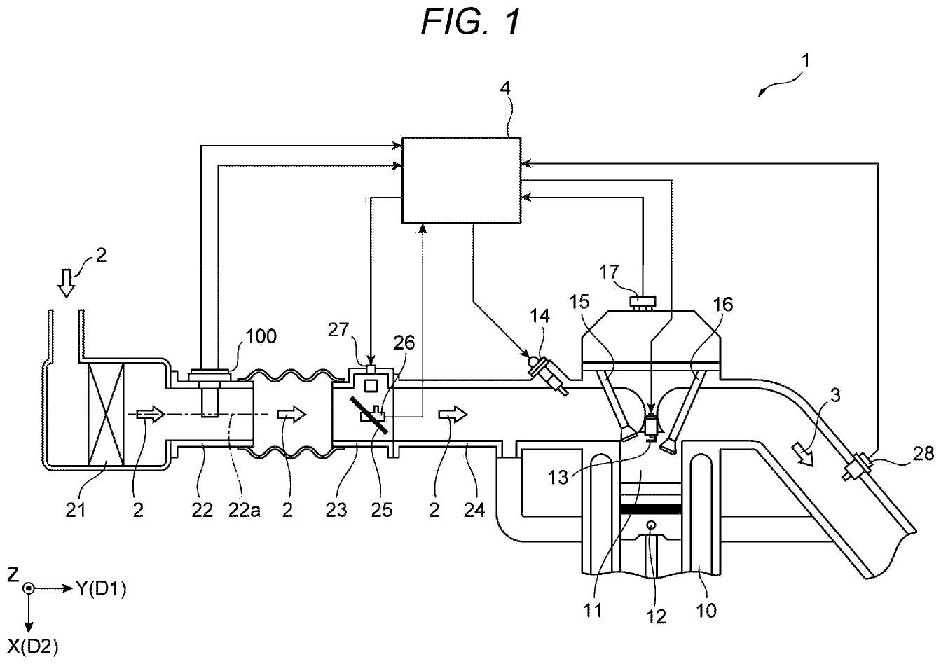

FIG. 1 is a system view illustrating an embodiment of a flow rate detection device according to the present disclosure. A physical quantity detection device 100 illustrated in FIG. 1 is an embodiment of the flow rate detection device according to the present disclosure, and is used in, for example, an electronic fuel injection type engine system 1. The engine system 1 includes, for example, an engine 10, the physical quantity detection device 100, a throttle valve 25, a throttle angle sensor 26, an idle air control valve 27, an oxygen sensor 28, and a control device 4.

The physical quantity detection device 100 is used, for example, in a state of being inserted into a main passage 22 from a mounting hole provided in a passage wall of an air intake body which is the main passage 22 and being fixed to the passage wall of the main passage 22. The physical quantity detection device 100 takes in a part of air as measurement target gas 2 taken in into the main passage 22 through an air cleaner 21 and flowing in a first direction D1 parallel to a center line 22a of the main passage 22.

The physical quantity detection device 100 detects a physical quantity of the taken-in air and outputs the physical quantity to the control device 4. The physical quantity detection device 100 protrudes in a radial direction of the main passage 22 from the passage wall of the main passage 22 toward the center line 22a of the main passage 22. That is, the protruding direction of the physical quantity detection device 100 in the main passage 22 is, for example, a second direction D2 orthogonal to the first direction D1 parallel to the center line 22a of the main passage 22.

The control device 4 is, for example, an electronic control unit (ECU) that controls the engine 10. The ECU is implemented by, for example, one or more microcontrollers, and includes a central processing unit (CPU) (not illustrated), a storage device such as a read only memory (ROM) or a flash memory, various computer programs and data stored in the storage device, a timer, and an input/output unit that communicates with peripheral devices.

The throttle valve 25 is incorporated in, for example, a throttle body 23 disposed upstream of an intake manifold 24 in a flow direction of the measurement target gas 2. The control device 4 changes an opening degree of the throttle valve 25 based on an operation amount of an accelerator pedal, for example, and controls a flow rate of intake air flowing into a combustion chamber in a cylinder 11 of the engine 10. The throttle angle sensor 26 measures the opening degree of the throttle valve 25 and outputs the opening degree to the control device 4. The idle air control valve 27 controls the amount of air to bypass the throttle valve 25.

The engine 10 includes, for example, the cylinder 11, a piston 12, an ignition plug 13, a fuel injection valve 14, an intake valve 15, an exhaust valve 16, and a rotation angle sensor 17. The intake air taken in through the air cleaner 21 based on the operation of the piston 12 of the engine 10 flows through the main passage 22, and the flow rate is controlled by the throttle valve 25 in the throttle body 23. The intake air that has passed through the throttle body 23 passes through the intake manifold 24, further passes the fuel injection valve 14 provided in an intake port, and flows into the combustion chamber in the cylinder 11 via the intake valve 15.

The control device 4 controls the fuel injection valve 14 based on a physical quantity of the intake air as the measurement target gas 2 input from the physical quantity detection device 100 to inject fuel toward the intake air. As a result, the intake air that has passed through the intake manifold 24 is mixed with the fuel injected from the fuel injection valve 14, and is guided to the combustion chamber in a mixed gas state. The control device 4 explosively burns the mixed gas in the combustion chamber by spark ignition of the ignition plug 13, and causes the engine 10 to generate mechanical energy.

The rotation angle sensor 17 detects information regarding positions and states of the piston 12, the intake valve 15, and the exhaust valve 16, and a rotation speed of the engine 10, and outputs the detected information to the control device 4. The gas generated by combustion is discharged from the combustion chamber of the cylinder 11 to an exhaust pipe through the exhaust valve 16, and is discharged from the exhaust pipe to the outside of the vehicle as exhaust gas 3. The oxygen sensor 28 is provided in the exhaust pipe, measures an oxygen concentration of the exhaust gas 3 flowing through the exhaust pipe, and outputs the oxygen concentration to the control device 4.

The control device 4 controls each unit of the engine system 1 based on the physical quantity of the intake air as the measurement target gas 2 flowing through the main passage 22 detected by the physical quantity detection device 100, for example, the flow rate, temperature, humidity, pressure, or the like. Specifically, when the control device 4 controls the opening degree of the throttle valve 25 based on the operation amount of the accelerator pedal, the flow rate of the intake air as the measurement target gas 2 flowing through the main passage 22 changes. The control device 4 controls a supply amount of the fuel to be injected from the fuel injection valve 14 based on, for example, the flow rate of the measurement target gas 2 detected by the physical quantity detection device 100. As a result, the mechanical energy generated by the engine 10 is controlled.

The control device 4 calculates a fuel injection amount and an ignition timing based on the physical quantity of the intake air, which is an output of the physical quantity detection device 100, and the rotation speed of the engine 10 measured based on the output of the rotation angle sensor 17. Based on these calculation results, the control device 4 controls the fuel injection amount of the fuel injection valve 14 and the ignition timing of the ignition plug 13.

In actual implementation, the control device 4 finely controls the fuel supply amount and the ignition timing based further on the temperature of the measurement target gas 2, a change state of the opening degree of the throttle valve 25, a change state of the rotation speed of the engine 10, and a state of an air-fuel ratio of the exhaust gas 3. In addition, the control device 4 controls the rotation speed of the engine 10 in an idle operation state by controlling the amount of air to bypass the throttle valve 25 with the idle air control valve 27 in the idle operation state of the engine 10.

Both of the fuel supply amount and the ignition timing, which are main control amounts of the engine 10, are calculated using the output of the physical quantity detection device 100 as a main parameter. Therefore, it is important to improve the measurement accuracy of the physical quantity detection device 100, suppress a change over time, and improve reliability in terms of improving vehicle control accuracy and ensuring the reliability.

Particularly, in recent years, there are a great demand for fuel efficiency of a vehicle, and a great demand for exhaust gas purification. To meet these demands, it is extremely important to improve the accuracy in detecting the physical quantity of the intake air, the physical quantity being detected by the physical quantity detection device 100. It is also important that the physical quantity detection device 100 maintains high reliability.

The vehicle in which the physical quantity detection device 100 is installed is used in an environment in which a change in temperature or humidity is large. It is desirable that the physical quantity detection device 100 can cope with a change in temperature and humidity in the use environment, and dust or contaminants.

In addition, the physical quantity detection device 100 is attached to an intake pipe that is affected by heat generated by the internal combustion engine. Therefore, the heat generated by the internal combustion engine is transferred to the physical quantity detection device 100 via the intake pipe. Since the physical quantity detection device 100 detects the flow rate of the measurement target gas 2 by performing heat transfer with the measurement target gas 2, it is important to suppress the influence of heat from the outside as much as possible.

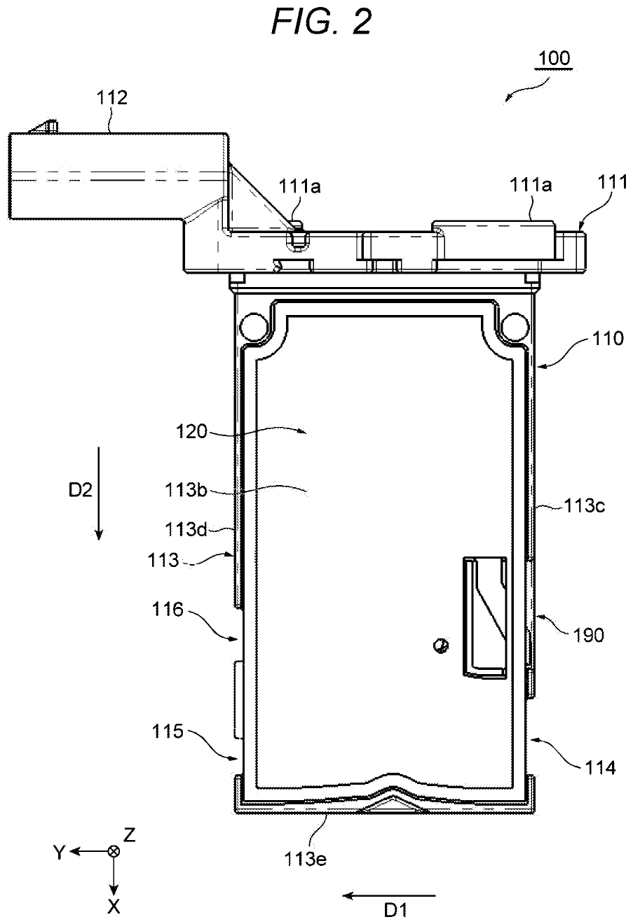

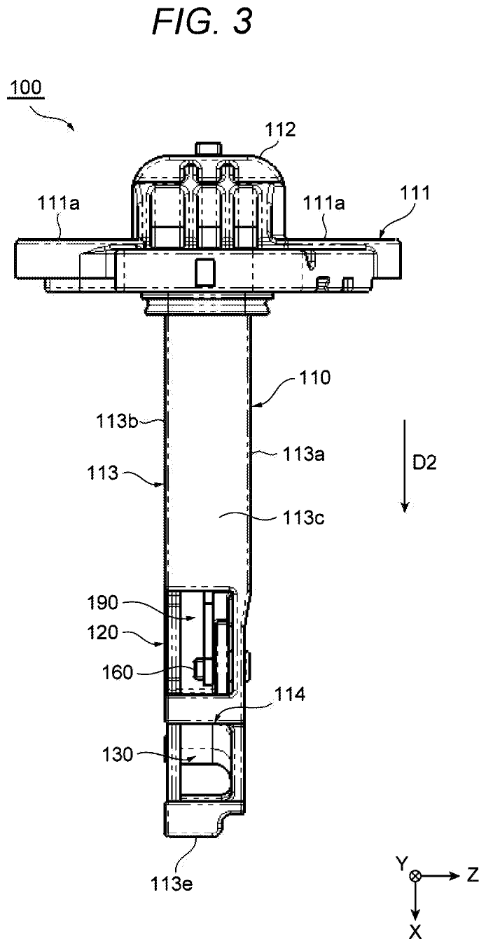

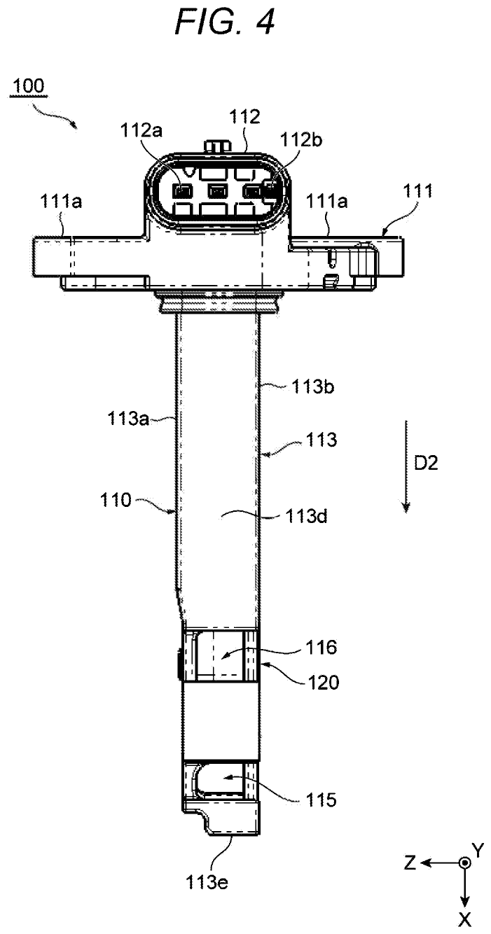

FIG. 2 is a rear view of the physical quantity detection device 100 provided in the main passage 22 of the engine system 1 of FIG. 1. FIG. 3 is a left side view of the physical quantity detection device 100 of FIG. 2. FIG. 4 is a right side view of the physical quantity detection device 100 of FIG. 2.

Hereinafter, each unit of the physical quantity detection device 100 may be described using an orthogonal coordinate system in which an X axis is parallel to the protruding direction (second direction D2) of the physical quantity detection device 100 in the main passage 22, a Y axis is parallel to the direction (first direction D1) of the center line 22a of the main passage 22, and a Z axis is orthogonal to the X axis and the Y axis. In the following description, it is assumed that the air taken in into the main passage 22 through the air cleaner 21 flows from the upstream side to the downstream side (positive Y-axis direction) of the main passage 22 in the first direction D1 parallel to the center line 22a (Y axis) of the main passage 22 during the forward flow.

The physical quantity detection device 100 includes, for example, a housing 110 and a cover 120. The housing 110 is manufactured, for example, by performing injection-molding of a synthetic resin material. The cover 120 is, for example, a plate-like member formed of a metal or a synthetic resin. As the cover 120, for example, a molded article of a synthetic resin material can be used. The housing 110 and the cover 120 constitute a casing of the physical quantity detection device 100 disposed in the main passage 22.

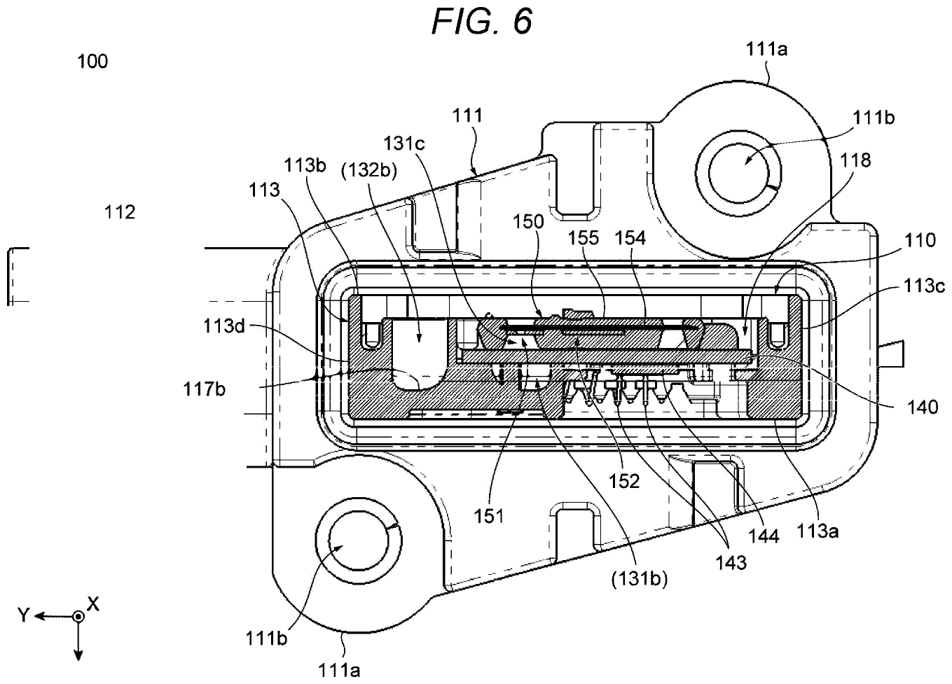

The housing 110 includes, for example, a flange 111, a connector 112, and a measurement portion 113. The flange 111 has a substantially rectangular plate shape in plan view in the second direction D2, and includes a pair of fixing portions 111a at diagonal corners. The fixing portion 111a has a through hole 111b (see FIG. 6) which is formed at a center portion of the fixing portion 111a and penetrates through the flange 111 and into which a fixing screw is inserted.

The physical quantity detection device 100 is fixed to the passage wall of the main passage 22 by, for example, the following procedure. First, the measurement portion 113 of the physical quantity detection device 100 is inserted into the main passage 22 through the mounting hole provided in the passage wall of the main passage 22, and the flange 111 is brought into contact with the passage wall of the main passage 22. Next, the fixing screw inserted into the through hole 111b of the flange 111 of the physical quantity detection device 100 is screwed into a screw hole of the passage wall of the main passage 22 and fastened. As a result, as illustrated in FIG. 1, the physical quantity detection device 100 is fixed to the main passage 22.

The connector 112 protrudes from the flange 111, is disposed outside the main passage 22, and is connected to the control device 4 via, for example, a connector and a cable (not illustrated). As illustrated in FIG. 4, a plurality of external terminals 112a and a correction terminal 112b are provided inside the connector 112. The external terminals 112a include, for example, an output terminal for the physical quantity such as the flow rate, temperature, or humidity, which is a measurement result of the physical quantity detection device 100, and a power supply terminal for supplying DC power for operating the physical quantity detection device 100.

The correction terminal 112b is used to measure the physical quantity after manufacturing the physical quantity detection device 100, obtain a correction value for each physical quantity detection device 100, and store the correction value in a memory inside the physical quantity detection device 100. In the subsequent measurement of the physical quantity by the physical quantity detection device 100, correction data based on the correction value stored in the memory is used, and the correction terminal 112b is not used.

The measurement portion 113 extends from the flange 111 fixed to the passage wall of the main passage 22 toward the center line 22a of the main passage 22 in such a way as to protrude in the radial direction (second direction D2) of the main passage 22 orthogonal to the center line 22a. The measurement portion 113 has a generally flat rectangular parallelepiped shape.

The measurement portion 113 has a length in the protruding direction (second direction D2) of the measurement portion 113 in the main passage 22 and a width in the main flow direction (first direction D1) of the air in the main passage 22. In addition, the measurement portion 113 has a thickness in a direction (Z-axis direction) orthogonal to the protruding direction (second direction D2 or X-axis direction) and the width direction (first direction D1 of Y-axis direction). As described above, since the measurement portion 113 has a flat shape in the main flow direction of the intake air flowing through the main passage 22, a fluid resistance to the intake air can be reduced.

The measurement portion 113 has a front surface 113a, a back surface 113b, an upstream side surface 113c, a downstream side surface 113d, and a lower surface 113e. The front surface 113a and the back surface 113b are larger in area than the other surfaces of the measurement portion 113, and are substantially parallel to the protruding direction of the measurement portion 113 (second direction D2) and the direction (first direction D1) of the center line 22a of the main passage 22. The upstream side surface 113c and the downstream side surface 113d have an elongated shape whose area is smaller than the front surface 113a and the back surface 113b, and are substantially orthogonal to the direction (first direction DO of the center line 22a of the main passage 22. The lower surface 113e has a smaller area than the other surfaces of the measurement portion 113, is generally parallel to the direction (first direction D1) of the center line 22a of the main passage 22, and is generally orthogonal to the protruding direction (second direction D2) of the measurement portion 113.

The measurement portion 113 includes an inlet 114 of a sub-passage described below in the upstream side surface 113c, and includes an outlet 116 of the sub-passage in the downstream side surface 113d. In addition, the measurement portion 113 may have a foreign matter discharge port 115 of the sub-passage in the downstream side surface 113d. The inlet 114, the outlet 116, and the foreign matter discharge port 115 of the sub-passage are provided at a distal end portion of the measurement portion 113 on a distal end side with respect to the center in the protruding direction (second direction D2) of the measurement portion 113. As a result, air in the vicinity of the center portion of the main passage 22 away from an inner wall surface of the main passage 22 can be taken in from the inlet 114. Therefore, the physical quantity detection device 100 can suppress a decrease in measurement accuracy due to an influence of heat of the engine 10.

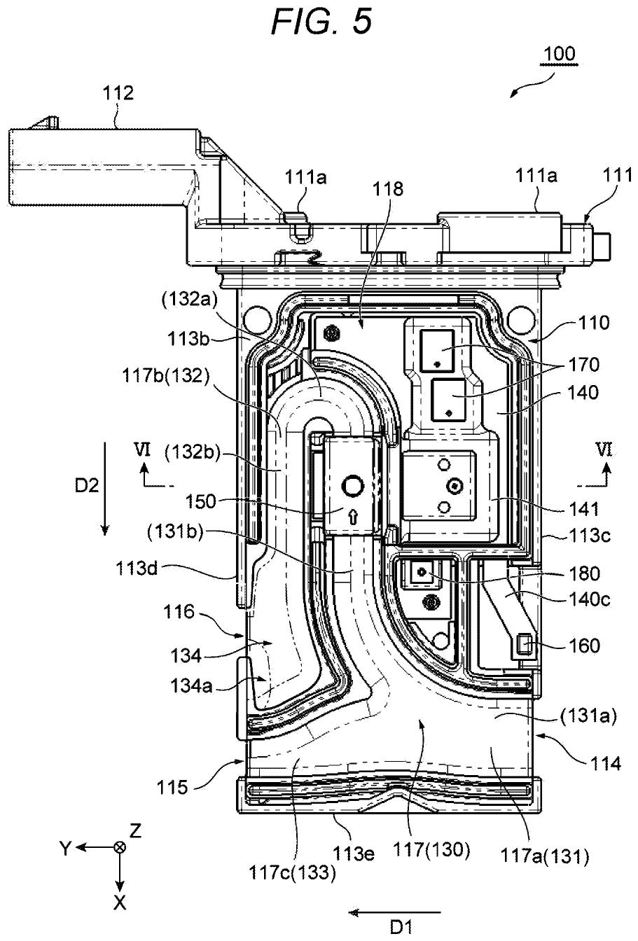

FIG. 5 is a rear view illustrating a state in which the cover 120 of the physical quantity detection device 100 of FIG. 2 is removed. FIG. 6 is a cross-sectional view of the physical quantity detection device 100 taken along line VI-VI of FIG. 5. The physical quantity detection device 100 of the present embodiment includes, for example, a sub-passage 130, a circuit board 140, and a chip package 150.

The external terminal 112a of the connector 112 illustrated in FIG. 4 is connected to a pad of the circuit board 140 via a bonding wire 143 illustrated in FIG. 6, for example. In the circuit board 140, for example, a protective circuit 144 is mounted on a surface to which the bonding wire 143 is connected. The protective circuit 144 stabilizes a voltage in the circuit and removes noise. The bonding wire 143 and the protective circuit 144 are covered and sealed with a sealing material (not illustrated). As the sealing material, for example, a silicone gel or an epoxy-based sealing material having a higher rigidity than that of a silicone-based sealing material can be used.

As illustrated in FIG. 5, the housing 110 includes a recessed sub-passage groove 117 and a recessed circuit chamber 118 on a back surface 113b side of the measurement portion 113. An opening of the sub-passage groove 117 is closed by the cover 120 illustrated in FIG. 2 to form the sub-passage 130 between the sub-passage groove 117 and the cover 120.

The sub-passage 130 includes, for example, the inlet 114, an inlet-side passage 131, an outlet-side passage 132, the outlet 116, a foreign matter discharge passage 133, and the foreign matter discharge port 115. For example, the sub-passage 130 takes in a part of air flowing through the main passage 22 from the inlet 114 opened toward the upstream side in the first direction D1, detours the air to the inlet-side passage 131, the outlet-side passage 132, and the foreign matter discharge passage 133, and returns the air to the main passage 22 from the outlet 116 and the foreign matter discharge port 115 opened toward the downstream side in the first direction D1.

The sub-passage groove 117 includes, for example, a first sub-passage groove 117a, a second sub-passage groove 117b, and a third sub-passage groove 117c. As illustrated in FIG. 5, the first sub-passage groove 117a extends in the first direction D1 from the inlet 114 opened in the upstream side surface 113c of the measurement portion 113, is curved from the first direction D1 toward the second direction D2, and is curved and extends toward the flange 111 of a proximal end portion of the measurement portion 113 in the second direction D2.

The inlet-side passage 131 of the sub-passage 130 is formed between the first sub-passage groove 117a and the cover 120. An upstream end of the inlet-side passage 131 is connected to the inlet 114. The inlet-side passage 131 includes, for example, an inlet-side upstream portion 131a extending from the inlet 114 in the first direction D1, and an inlet-side downstream portion 131b extending from the inlet-side upstream portion 131a in the second direction D2 orthogonal to the first direction D1 and having a downstream end at which a thermal flow sensor 151 is disposed.

The third sub-passage groove 117c branches from the first sub-passage groove 117a and extends in the first direction D1 to the foreign matter discharge port 115 opened in the downstream side surface 113d of the measurement portion 113. The foreign matter discharge passage 133 extending in the first direction D1 from the inlet-side upstream portion 131a toward the foreign matter discharge port 115 is formed between the third sub-passage groove 117c and the cover 120. The foreign matter discharge passage 133 returns a part of the air taken in from the inlet 114 to the main passage 22 from the foreign matter discharge port 115, together with foreign matters such as dust taken in from the inlet 114. The foreign matter discharge port 115 is opened toward the downstream side in the first direction D1 at a position away from the outlet 116 in the second direction D2 beyond a downstream end of an outlet-side downstream portion 132b.

The second sub-passage groove 117b is curved in a U shape in such a way as to be folded back in a direction opposite to the second direction D2 from a downstream end of the first sub-passage groove 117a, and further extends toward the outlet 116 of the distal end portion of the measurement portion 113 in the second direction D2. The outlet-side passage 132 of the sub-passage 130 is formed between the second sub-passage groove 117b and the cover 120. The outlet-side passage 132 includes, for example, an outlet-side upstream portion 132a and the outlet-side downstream portion 132b.

The outlet-side upstream portion 132a is curved in, for example, a U shape in such a way as to be folded back in the direction opposite to the second direction D2 from the inlet-side downstream portion 131b, that is, toward the distal end portion in the protruding direction of the measurement portion 113. The outlet-side downstream portion 132b extends, for example, in the second direction D2 from a downstream end of the outlet-side upstream portion 132a toward the outlet 116, and an attenuation chamber 134 is provided at the downstream end. Further, the downstream end of the outlet-side downstream portion 132b extends in the second direction D2 beyond the outlet 116, for example, and forms a recessed portion 134a in the attenuation chamber 134.

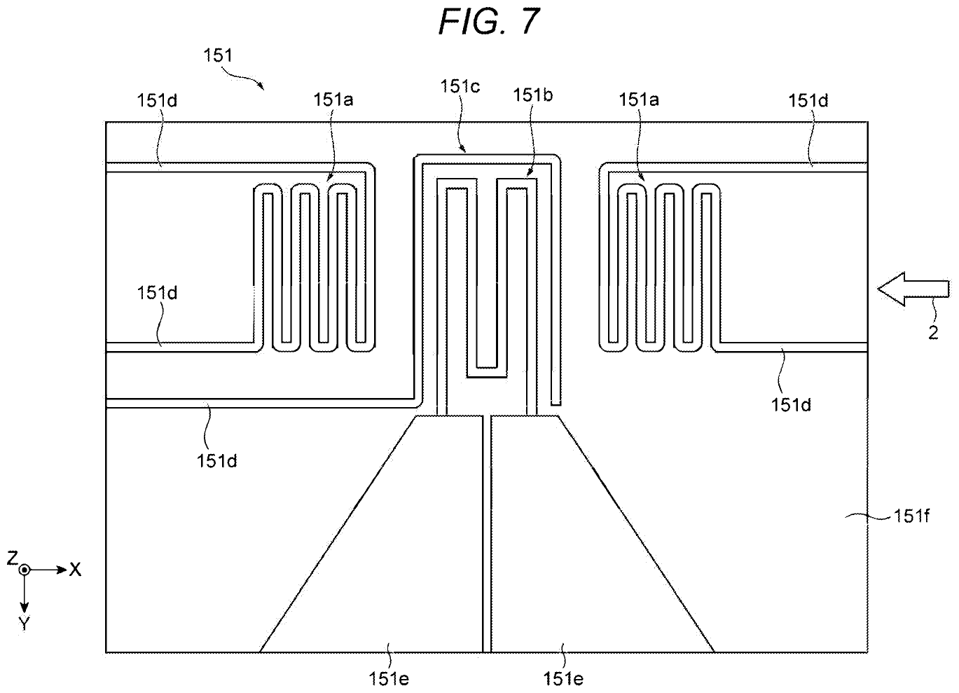

FIG. 7 is an enlarged schematic plan view of the thermal flow sensor 151 illustrated in FIG. 6. The thermal flow sensor 151 includes two temperature detection portions 151a arranged at an interval in the flow direction (X-axis direction) of the air which is the measurement target gas 2 in the thermal flow sensor 151, and a heating portion 151b disposed between the two temperature detection portions 151a. The thermal flow sensor 151 further includes, for example, a heating temperature detection portion 151c disposed between the heating portion 151b and the two temperature detection portions 151a.

The temperature detection portion 151a, the heating portion 151b, and the heating temperature detection portion 151c are provided, for example, on a protective film 151f formed on a surface of a semiconductor substrate such as a silicon substrate. The protective film 151f is, for example, a multi-layered thin film having an electrical insulation property, such as a silicon dioxide film or silicon nitride film. In a region where the temperature detection portion 151a, the heating portion 151b, and the heating temperature detection portion 151c are formed on the protective film 151f, a cavity is formed in the silicon substrate, and the protective film 151f forms a diaphragm facing the cavity of the silicon substrate.

The pair of temperature detection portions 151a and the heating portion 151b are formed of, for example, wires meandering in such a way as to reciprocate in the direction (Y-axis direction) orthogonal to the flow direction (X-axis direction) of the measurement target gas 2. The heating temperature detection portion 151c is provided around the heating portion 151b in such a way as to surround three sides of the heating portion 151b, for example, and is disposed between the temperature detection portions 151a and the heating portion 151b. As materials of the temperature detection portion 151a, the heating portion 151b, and the heating temperature detection portion 151c, for example, a semiconductor material such as polycrystalline silicon or monocrystalline silicon doped with impurities, or a metal material such as platinum, molybdenum, tungsten, or a nickel alloy can be used.

For example, a plurality of wirings 151d is connected to the thermal flow sensor 151. More specifically, in the pair of temperature detection portions 151a of the thermal flow sensor 151, the wiring 151d is connected to each of both ends of one temperature detection portion 151a and both ends of the other temperature detection portion 151a. The wiring 151d is also connected to one end of the heating temperature detection portion 151c. Each wiring 151d extends, for example, in the flow direction (X-axis direction) of the measurement target gas 2. Each of one end and the other end of the heating portion 151b is connected to, for example, a terminal 151e. As the material of the wiring 151d, for example, the same materials as those of the temperature detection portion 151a, the heating portion 151b, and the heating temperature detection portion 151c can be used.

As described above, the physical quantity detection device 100 is used, for example, in a state of being fixed to the passage wall of the intake body which is the main passage 22. For example, the physical quantity detection device 100 takes in the intake air, which is the measurement target gas 2 taken in through the air cleaner 21 and flowing through the main passage 22, from the inlet 114 provided in the measurement portion 113 of the housing 110 into the sub-passage 130. The measurement target gas 2 taken in into the sub-passage 130 flows along the thermal flow sensor 151 illustrated in FIG. 7 when passing through a recessed groove of a distal end portion of the chip package 150 protruding to the sub-passage 130.

When the measurement target gas 2 passes through the thermal flow sensor 151, the gas heated by the heating portion 151b moves to the temperature detection portion 151a positioned on a downstream side of the measurement target gas 2 among the pair of temperature detection portions 151a. This causes a difference in temperature detected by the pair of temperature detection portions 151a. The thermal flow sensor can detect the flow rate of the air, which is the measurement target gas 2, and the forward flow or the reverse flow of the air based on the temperature difference detected by the pair of temperature detection portions 151a.

As illustrated in FIG. 5, at least one of a temperature sensor 160, a pressure sensor 170, or a humidity sensor 180 is mounted on the circuit board 140 in addition to the chip package 150 including the thermal flow sensor 151. A connection terminal of each sensor is sealed by, for example, a sealing material 141. In the present embodiment, the temperature sensor 160, the pressure sensor 170, and the humidity sensor 180 are mounted on the circuit board 140, but any one of the sensors may be omitted.

The temperature detection passage 190 illustrated in FIGS. 2 and 3 includes an inlet in the upstream side surface 113c of the measurement portion 113, and includes outlets in both the front surface 113a and the back surface 113b of the measurement portion 113. The temperature detection passage 190 takes in the air flowing through the main passage 22 from the inlet opened in the upstream side surface 113c of the measurement portion 113, and discharges the air to the main passage 22 from the outlets opened in the front surface 113a and the back surface 113b of the measurement portion 113. With such a configuration, a heat dissipation property of the temperature sensor 160 can be improved.

The pressure sensor 170 is mounted on the circuit board 140 and disposed in the circuit chamber 118, for example. The circuit chamber 118 communicates with the outlet-side upstream portion 132a of the sub-passage 130 curved in a U shape in the vicinity of the flange 111. As a result, a pressure of the gas flowing through the sub-passage 130 can be measured by the pressure sensor 170 disposed in the circuit chamber 118.

The humidity sensor 180 is mounted on the circuit board 140, for example, and is disposed in a partitioned region on a distal end side of the measurement portion 113 with respect to the circuit chamber 118. The humidity sensor 180 detects, for example, a humidity of the gas taken in into the sub-passage 130 from the main passage 22.

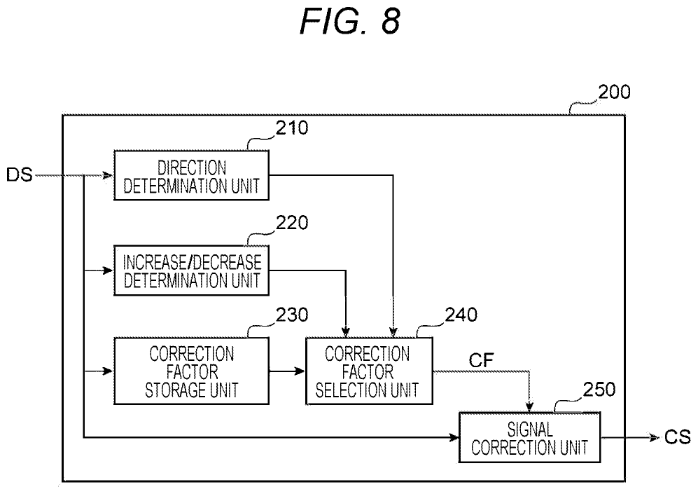

FIG. 8 is a functional block diagram of a signal processing device 200 that processes a detection signal of the thermal flow sensor 151. The signal processing device 200 is, for example, a microcontroller including a CPU, a memory, a timer, and an input/output unit. The signal processing device 200 is mounted on, for example, the circuit board 140 or the chip package 150 of the physical quantity detection device 100. Note that the signal processing device 200 may be implemented by, for example, a part of the control device 4 connected to the physical quantity detection device 100.

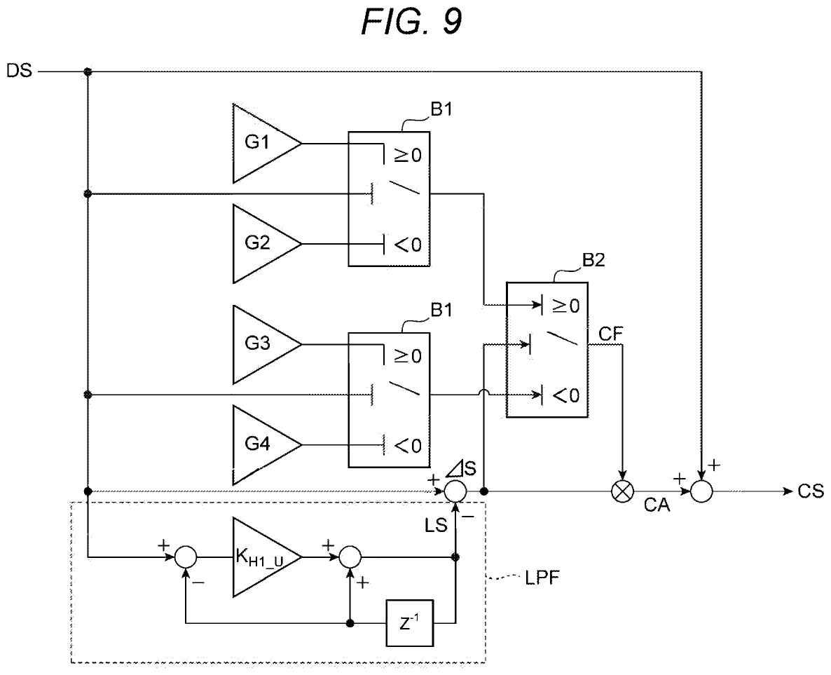

The signal processing device 200 includes a direction determination unit 210, an increase/decrease determination unit 220, a correction factor storage unit 230, a correction factor selection unit 240, and a signal correction unit 250. Each unit of the signal processing device 200 illustrated in FIG. 8 represents, for example, each function of the signal processing device 200 implemented by executing a program stored in a memory by a CPU. Hereinafter, an operation of the signal processing device 200 of the present embodiment will be described with reference to FIG. 9.

FIG. 9 is a block diagram illustrating a flow of signal processing in the signal processing device 200. When a detection signal DS for the air flow rate is input from the thermal flow sensor 151 to the signal processing device 200, the direction determination unit 210 determines the forward flow or the reverse flow of the air based on the detection signal DS (block B1). In addition, the increase/decrease determination unit 220 determines an increase or decrease in flow rate of the air based on the detection signal DS (block B2). More specifically, the increase/decrease determination unit 220 has, for example, a function of a low-pass filter LPF illustrated in FIG. 9.

For example, the increase/decrease determination unit 220 determines the increase or decrease in flow rate of the air passing through the thermal flow sensor 151 based on a difference ΔS between an output LS of the low-pass filter LPF with the detection signal DS as an input and the detection signal DS which is the input of the low-pass filter LPF (block B2). More specifically, the increase/decrease determination unit 220 determines an increase or decrease in flow rate of the air based on whether the difference ΔS is less than 0 (ΔS≤0) or equal to or more than 0 (ΔS≥0) (block B2).

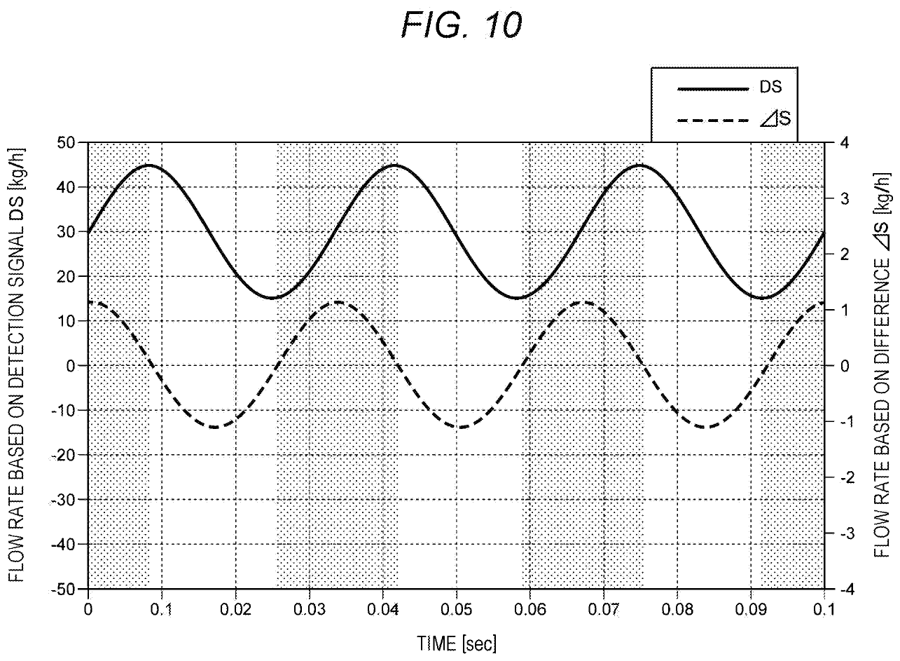

FIG. 10 is a graph illustrating an example of a relationship between the difference ΔS illustrated in FIG. 9 and the detection signal DS of the thermal flow sensor 151. FIG. 10 is a graph obtained by computer simulation with a calculation cycle of the signal processing device 200 set to 5 [kHz] and a value of K_{H1_U} of the low-pass filter LPF illustrated in FIG. 9 set to 0.33.

As illustrated in FIG. 10, in a case where the flow rate based on the difference ΔS is less than 0 (<0), the flow rate based on the detection signal DS decreases, and in a case where the flow rate based on the difference ΔS is equal to or more than 0 (≥0), the flow rate based on the detection signal DS increases. Therefore, the increase/decrease determination unit 220 can determine the decrease in flow rate of the air in a case where the difference ΔS is less than 0 (ΔS<0), and can determine the increase in flow rate of the air in a case where the difference ΔS is equal to or more than 0 (ΔS≥0) (block B2).

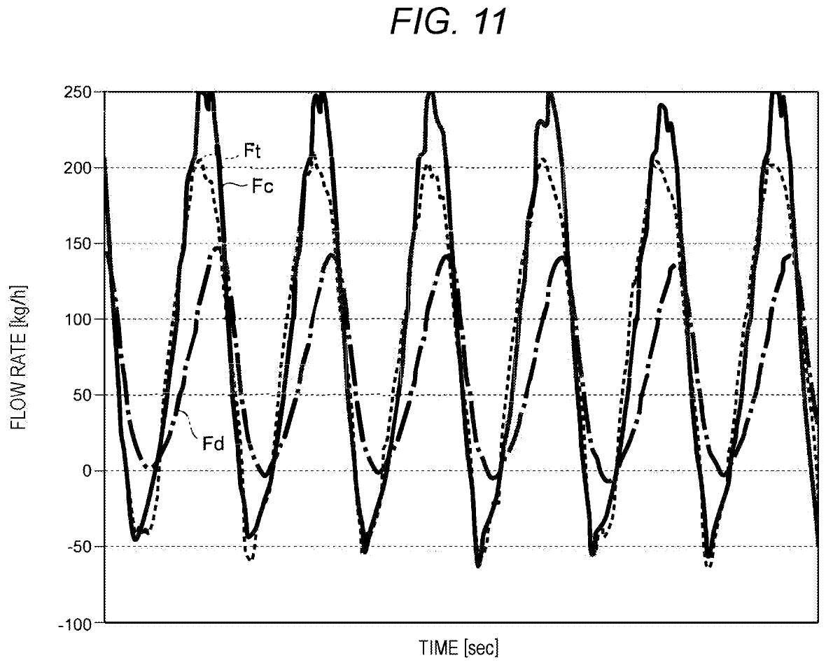

Here, the correction factor storage unit 230 stores a first factor G1, a second factor G2, a third factor G3, and a fourth factor G4 used for correcting the detection signal DS of the thermal flow sensor 151. The correction factor selection unit 240 selects the first factor G1, the second factor G2, the third factor G3, or the fourth factor G4 as a correction factor CF based on determination results of the direction determination unit 210 and the increase/decrease determination unit 220 (blocks B1 and B2). Hereinafter, the first factor G1, the second factor G2, the third factor G3, and the fourth factor G4 will be described with reference to FIG. 11.

FIG. 11 is a graph of a flow rate waveform with a vertical axis representing a flow rate of air and a horizontal axis representing time. In FIG. 11, a true flow rate waveform Ft of the air flowing through the main passage 22 is indicated by a broken line, a flow rate waveform Fd based on the detection signal DS of the thermal flow sensor 151 is indicated by a line with alternating long and short dashes, and a flow rate waveform Fc based on a corrected signal CS obtained by correcting the detection signal DS is indicated by a solid line. The first factor G1, the second factor G2, the third factor G3, and the fourth factor G4 described above can be determined, for example, as follows.

As indicated by the true flow rate waveform Ft illustrated in FIG. 11, the physical quantity detection device 100 is disposed in a known air flow in which the flow rate of the air changes in a sine wave form and pulsates in such a way as to alternately repeat the forward flow and the reverse flow at a predetermined cycle. Then, based on comparison between the true flow rate waveform Ft and the flow rate waveform Fd based on the detection signal DS of the thermal flow sensor 151, the first factor G1 to the fourth factor G4 as the correction factors are determined in order to bring the flow rate waveform Fd close to the true flow rate waveform Ft. Note that these factors may be determined by, for example, computer simulation using a computer model of the physical quantity detection device 100.

More specifically, as described above, the thermal flow sensor 151 is installed in the sub-passage 130 of the physical quantity detection device 100. In addition, the sub-passage 130 includes the inlet 114 for taking in the forward flow of air flowing through the main passage 22 in which the physical quantity detection device 100 is installed, and the outlet 116 for discharging the air taken in from the inlet 114 to the main passage 22. However, as described above, in the sub-passage 130, the shape of the inlet-side passage 131 between the inlet 114 and the thermal flow sensor 151 is different from the shape of the outlet-side passage 132 between the outlet 116 and the thermal flow sensor 151.

Therefore, even in a case where the flow rate of the air passing through the physical quantity detection device 100 is equal between the forward flow and the reverse flow of the air flowing through the main passage 22, the flow rate of the air flowing from the inlet 114 to the outlet 116 in the sub-passage 130 is different from the flow rate of the air flowing from the outlet 116 to the inlet 114 in the reverse flow. This is because the shape of the inlet-side passage 131 is different from the shape of the outlet-side passage 132. That is, the flow rate waveform Fd based on the detection signal DS of the thermal flow sensor 151 disposed in the sub-passage 130 is asymmetric between the forward flow and the reverse flow of the air flowing through the main passage 22.

Therefore, in order to detect the flow rate of the air with higher accuracy by the thermal flow sensor 151 in the forward flow and the reverse flow of the air in the main passage 22, the flow rate waveform Fd based on the detection signal DS is divided into the first to fourth quadrants. The first quadrant is a case where the air flow is the forward flow and the flow rate of the air is increasing. The second quadrant is a case where the air flow is the forward flow and the flow rate is decreasing. The third quadrant is a case where the air flow is the reverse flow and the flow rate is increasing. The fourth quadrant is a case where the air flow is the reverse flow and the flow rate is decreasing.

In other words, the first quadrant corresponds to a case where the flow rate is positive and a differential value of the flow rate waveform is positive, that is, the rise of the flow rate in a forward flow region or a flow velocity increasing phase in the forward flow region. The second quadrant corresponds to a case where the flow rate is positive and the differential value of the flow rate waveform is negative, that is, the fall of the flow rate in the forward flow region or a flow velocity decreasing phase in the forward flow region. The third quadrant corresponds to a case where the flow rate is negative and the differential value of the flow rate waveform is negative, that is, the rise of the flow rate in a reverse flow region or a flow velocity increasing phase in the reverse flow region. The fourth quadrant corresponds to a case where the flow rate is negative and the differential value of the flow rate waveform is positive, that is, the fall of the flow rate in the reverse flow region or a flow velocity decreasing phase in the reverse flow region.

The first factor G1, the third factor G3, the second factor G2, and the fourth factor G4 are determined for the first quadrant, the second quadrant, the third quadrant, and the fourth quadrant of the detection signal DS of the thermal flow sensor 151, and are stored in the correction factor storage unit 230. One of these factors is selected as the correction factor CF by the correction factor selection unit 240.

In a case where the determination result of the direction determination unit 210 indicates the forward flow (block B1: ≥0) and the determination result of the increase/decrease determination unit 220 indicates the increase in flow rate (block B2: ≥0), that is, in the first quadrant, the correction factor selection unit 240 selects the first factor G1 as the correction factor CF. In a case where the determination result of the direction determination unit 210 indicates the reverse flow (block B1: <0) and the determination result of the increase/decrease determination unit 220 indicates the increase in flow rate (block B2: ≥0), that is, in the third quadrant, the correction factor selection unit 240 selects the second factor G2.

In a case where the determination result of the direction determination unit 210 in the third quadrant the forward flow (block B1: ≥0) and the decrease in flow rate of the increase/decrease determination unit 220 (block B2: <0), that is, in the second quadrant, the correction factor selection unit 240 selects the third factor G3 as the correction factor CF. In a case where the determination result of the direction determination unit 210 indicates the reverse flow (block B1: <0) and the determination result of the increase/decrease determination unit 220 indicates the decrease in flow rate (block B2: <0), that is, in the fourth quadrant, the correction factor selection unit 240 selects the fourth factor G4.

The signal correction unit 250 corrects the detection signal by using the correction factor CF. More specifically, for example, as illustrated in FIG. 9, the signal correction unit 250 calculates a correction amount CA by multiplying the difference ΔS between the output LS of the low-pass filter LPF with the detection signal DS as an input and the detection signal DS by the correction factor CF. The signal correction unit 250 outputs the corrected signal CS obtained by correcting the detection signal DS by adding the calculated correction amount CA and the detection signal DS.

As a result, as illustrated in FIG. 11, the signal processing device 200 corrects the flow rate waveform Fd based on the detection signal DS of the thermal flow sensor 151 attenuated with respect to the true flow rate waveform Ft, and outputs the flow rate waveform Fc based on the corrected signal CS matching the true flow rate waveform Ft with high accuracy.

Hereinafter, actions of the physical quantity detection device 100, the signal processing device 200, and the signal processing method of the present embodiment will be described.

For example, when a variable valve mechanism is employed in the engine system 1 mounted on an automobile, pulsation of intake air including a reverse flow region is likely to occur in a case of air passing through the main passage 22 and sucked into the engine 10. The thermal flow sensor 151 incorporated in the physical quantity detection device 100 installed in the main passage 22 detects the flow rate of the intake air as the measurement target gas 2 passing through the main passage 22.

However, as illustrated in FIG. 11, the flow rate waveform Fd based on the detection signal DS of the thermal flow sensor 151 is attenuated due to a response delay with respect to the true flow rate waveform Ft of the intake air particularly during high-frequency pulsation of the intake air occurring at the time of high-speed rotation of the engine 10. As a result, the flow rate based on the detection signal DS of the thermal flow sensor 151 causes an error in the true flow rate of the intake air. The above-described thermal air flowmeter according to the related art described in PTL 1 can accurately detect the air flow rate even in an engine system with a large air pulsation, but there is room for improvement in accuracy in detecting a flow rate during pulsation of intake air including a reverse flow region.

On the other hand, the physical quantity detection device 100 of the present embodiment includes the thermal flow sensor 151 that is capable of detecting the forward flow and the reverse flow of air, and the signal processing device 200 that processes the detection signal DS of the thermal flow sensor 151. The signal processing device 200 includes a direction determination unit 210, an increase/decrease determination unit 220, a correction factor storage unit 230, a correction factor selection unit 240, and a signal correction unit 250. The direction determination unit 210 determines the forward flow or the reverse flow of the air based on the detection signal of the thermal flow sensor 151. The increase/decrease determination unit 220 determines the increase or decrease in flow rate of the air based on the detection signal of the thermal flow sensor 151. The correction factor storage unit 230 stores the first factor G1, the second factor G2, the third factor G3, and the fourth factor G4 used for correcting the detection signal DS of the thermal flow sensor 151. The correction factor selection unit 240 selects the first factor G1, the second factor G2, the third factor G3, or the fourth factor G4 as the correction factor CF based on the determination results of the direction determination unit 210 and the increase/decrease determination unit 220. The signal correction unit 250 corrects the detection signal DS by using the correction factor CF. The correction factor selection unit 240 selects the first factor G1 in a case of the forward flow of the air and the increase in flow rate, selects the second factor G2 in a case of the reverse flow and the increase in flow rate, selects the third factor G3 in a case of the forward flow and the decrease in flow rate, and selects the fourth factor G4 in a case of the reverse flow and the decrease in flow rate.

With such a configuration, as described above, the physical quantity detection device 100 and the signal processing device 200 of the present embodiment can correct the detection signal DS of the thermal flow sensor 151 and output the flow rate waveform Fc matching the true flow rate waveform Ft including the reverse flow region with high accuracy. Therefore, with the physical quantity detection device 100 and the signal processing device 200 of the present embodiment, the accuracy in detecting the air flow rate during pulsation of the intake air including the reverse flow region can be improved as compared with the thermal air flowmeter according to the related art. Therefore, with the physical quantity detection device 100 and the signal processing device 200 of the present embodiment, for example, the flow rate of the intake air as the measurement target gas 2 can be detected with high accuracy during high-frequency pulsation of the intake air occurring at the time of high-speed rotation of the engine 10 in which the variable valve mechanism is employed. As a result, the engine 10 can be controlled with high accuracy by the control device 4.

In addition, as illustrated in FIGS. 5 and 6, the physical quantity detection device 100 of the present embodiment includes the sub-passage 130 in which the thermal flow sensor 151 is disposed. The sub-passage 130 includes the inlet 114 for taking in the forward flow of air from the main passage 22 in which the physical quantity detection device 100 is installed, and the outlet 116 for discharging the air taken in from the inlet 114 to the main passage 22. The sub-passage 130 includes the inlet-side passage 131 between the inlet 114 and the thermal flow sensor 151, and the outlet-side passage 132 between the thermal flow sensor 151 and the outlet 116. The inlet-side passage 131 and the outlet-side passage 132 have different shapes.

With such a configuration, in the physical quantity detection device 100 of the present embodiment, a pressure loss factor for the air during the forward flow through the sub-passage 130 from the inlet 114 to the outlet 116 is different from a pressure loss factor for the air during the reverse flow through the sub-passage 130 from the outlet 116 to the inlet 114. Therefore, the flow rate and the flow velocity of the air flowing through the sub-passage 130 is asymmetric between the forward flow and the reverse flow. However, in the physical quantity detection device 100 and the signal processing device 200 of the present embodiment, as described above, one of the first factor G1 to the fourth factor G4 can be selected as the correction factor CF according to a combination of the forward flow or reverse flow of the air and the increase or decrease in flow rate by the correction factor selection unit 240. Therefore, the detection signal DS of the thermal flow sensor 151 can be corrected by the signal correction unit 250 using the correction factor CF selected by the correction factor selection unit 240. Therefore, with the physical quantity detection device 100 and the signal processing device 200, the flow rate waveform Fc corrected by the signal correction unit 250 can match the true flow rate waveform Ft including the reverse flow region with high accuracy.

In addition, in the physical quantity detection device 100 of the present embodiment, as illustrated in FIG. 7, the thermal flow sensor 151 includes two temperature detection portions 151a arranged at an interval in the flow direction of the air which is the measurement target gas 2, and the heating portion 151b disposed between the two temperature detection portions 151a.

With such a configuration, a temperature distribution is generated between the two temperature detection portions 151a by heat generated by the heating portion 151b, and the temperature distribution changes depending on the flow direction of the air as the measurement target gas 2. The thermal flow sensor 151 can detect the forward flow and the reverse flow of the air by detecting the change in temperature distribution by the two temperature detection portions 151a. However, in the thermal flow sensor 151 having such a configuration, the responsiveness of the flow rate is different between when the flow rate of the air increases and when the flow rate decreases. In the physical quantity detection device 100 and the signal processing device 200 of the present embodiment, even in a case where such a thermal flow sensor 151 is used, one of the first factor G1 to the fourth factor G4 can be selected as the correction factor CF according to a combination of the forward flow or reverse flow of the air and the increase or decrease in flow rate. Therefore, with the physical quantity detection device 100 and the signal processing device 200, the flow rate waveform Fc corrected by the signal correction unit 250 can match the true flow rate waveform Fc including the reverse flow region with high accuracy.

In addition, as described above, the physical quantity detection device 100 and the signal processing device 200 of the present embodiment correct the detection signal DS by using the difference ΔS between the output LS of the low-pass filter LPF with the detection signal DS of the thermal flow sensor 151 as an input and the detection signal DS. That is, the signal processing device 200 includes, for example, a memory that stores the previous value and the latest value of the detection signal DS of the thermal flow sensor 151. For example, the signal correction unit 250 corrects the latest value by using a differential value of the detection signal DS based on a difference between the previous value and the latest value of the detection signal DS.

With this configuration, the physical quantity detection device 100 and the signal processing device 200 of the present embodiment can detect the increase in flow rate and the decrease in flow rate of the air by using one storage region of the memory that stores the difference between the previous value and the latest value of the detection signal DS, and perform correction according to a change amount per unit time. As a result, the memory required for the correction calculation can be minimized, and cost reduction and minimization of a calculation delay can be achieved.

That is, the physical quantity detection device 100 and the signal processing device 200 of the present embodiment do not directly obtain a value of a pulsation frequency of the air and provide a correction amount corresponding thereto, but detect the rise and fall of a pulsation waveform and perform correction according to a change amount per unit time. Then, the physical quantity detection device 100 and the signal processing device 200 of the present embodiment calculate a difference from the previous value by using only one storage region of the memory in order to detect the rising edge and the falling edge. As a result, the memory required for the correction calculation can be minimized, and minimization of costs and a calculation delay can be achieved.

As described above, the signal processing method of the present embodiment is a method of processing the detection signal DS of the thermal flow sensor 151 capable of detecting the forward flow and the reverse flow of the air. In the signal processing method of the present embodiment, the forward flow or the reverse flow of air is detected based on the detection signal DS, and the increase or decrease in flow rate of the air is determined based on the detection signal DS. In the signal processing method of the present embodiment, the first factor G1, the second factor G2, the third factor G3, or the fourth factor G4 is selected as the correction factor CF based on the determination result indicating the forward flow or the reverse flow and the determination result indicating the increase or decrease in flow rate, and the detection signal DS is corrected using the correction factor CF. In the signal processing method of the present embodiment, in the selection of the correction factor CF, the first factor G1 is selected in a case of the forward flow of the air and the increase in flow rate, the second factor G2 is selected in a case of the reverse flow and the increase in flow rate, the third factor G3 is selected in a case of the forward flow and the decrease in flow rate, and the fourth factor G4 is selected in a case of the reverse flow and the decrease in flow rate. With such a configuration, in the signal processing method of the present embodiment, it is possible to achieve effects similar to those of the physical quantity detection device 100 and the signal processing device 200 described above.

As described above, according to the present embodiment, it is possible to provide the physical quantity detection device 100, the signal processing device 200, and the signal processing method capable of improving accuracy in detecting an air flow rate by the thermal flow sensor 151 during pulsation of air including a reverse flow region. Note that the physical quantity detection device and the signal processing device according to the present disclosure are not limited to the above-described embodiments. Hereinafter, some modified examples of the physical quantity detection device 100 and the signal processing device 200 according to the above-described embodiment will be described.

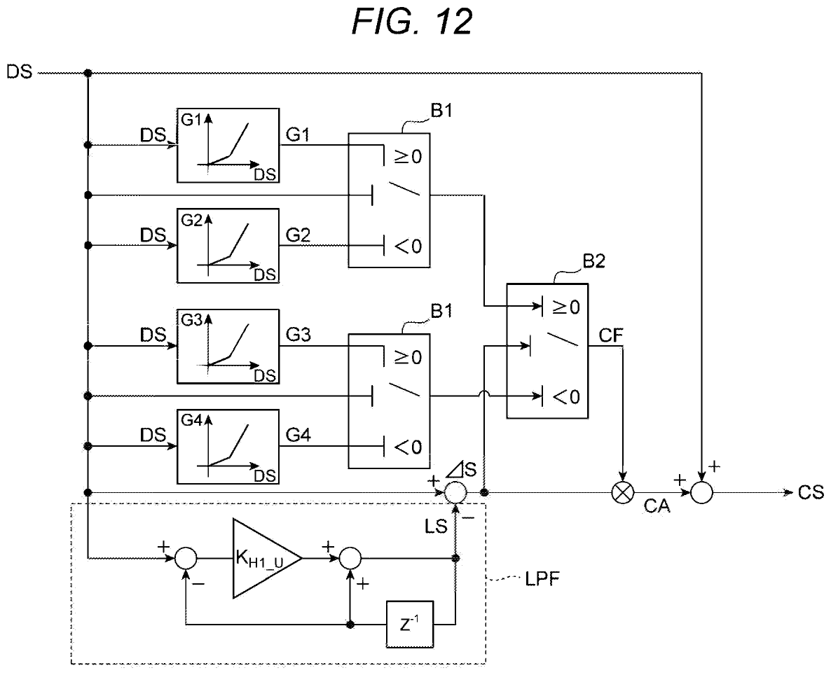

FIG. 12 is a block diagram illustrating a first modified example of the physical quantity detection device 100 and the signal processing device 200 according to the above-described embodiment. Note that the block diagram of FIG. 12 is a block diagram illustrating a flow of signal processing in the physical quantity detection device 100 and the signal processing device 200 according to this modified example, which corresponds to the block diagram of FIG. 9 of the above-described embodiment. In this modified example, at least one of the first factor G1, the second factor G2, the third factor G3, or the fourth factor G4 stored in the correction factor storage unit 230 is determined according to the flow rate of the air based on the detection signal DS of the thermal flow sensor 151.

With such a configuration, in the physical quantity detection device 100 and the signal processing device 200 of this modified example, at least one of the first factor G1 to the fourth factor G4 has dependency on the air flow rate, and the detection signal DS can be optimally corrected according to the state of the air flow. Even in a case where the first factor G1 to the fourth factor G4 are set to optimum fixed values for the first quadrant to the fourth quadrant of the flow rate waveform based on the detection signal DS of the thermal flow sensor 151, respectively, sufficient contribution to improvement in accuracy in detecting the air flow rate is made. However, in each of the forward flow region and the reverse flow region of the air, the state of the air flow changes according to the flow rate, and the change in state may affect the responsiveness of the thermal flow sensor 151.

More specifically, it is conceivable that the state of the air flow changes to, for example, a laminar flow state, a transition state, a turbulent flow state, or the like according to the flow rate, and a heat transfer factor from the thermal flow sensor 151 to the air changes in each state, and the responsiveness of the thermal flow sensor 151 changes. Even in such a case, in the physical quantity detection device 100 and the signal processing device 200 of this modified example, at least one of the first factor G1 to the fourth factor G4 has dependency on the air flow rate, and the detection signal DS can be optimally corrected according to the state of the air flow.

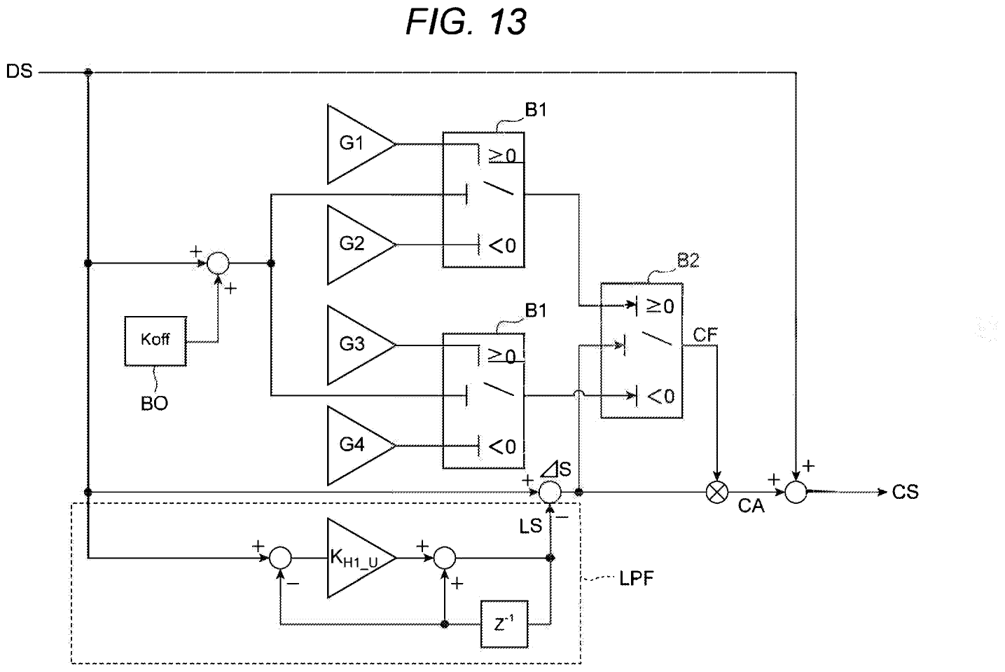

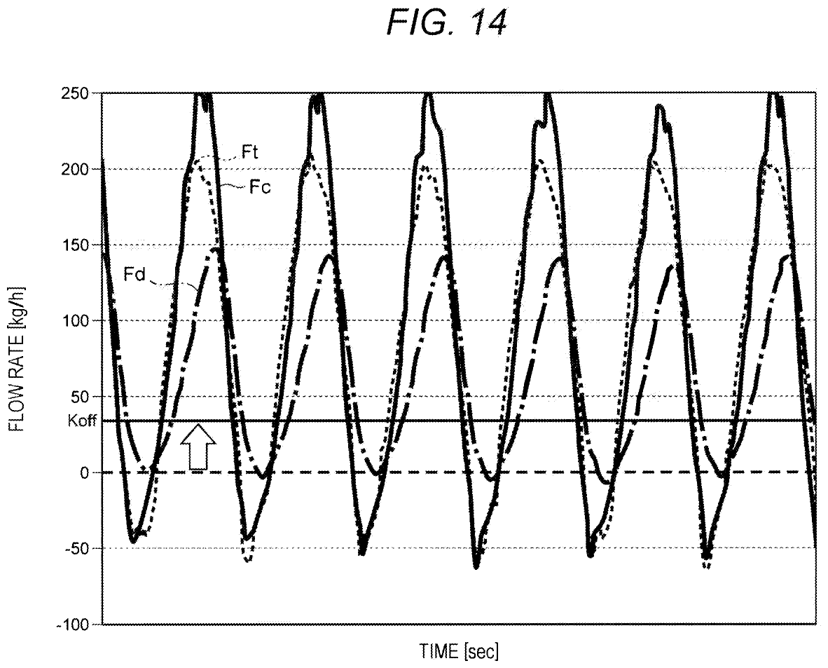

FIG. 13 is a block diagram illustrating a second modified example of the physical quantity detection device 100 and the signal processing device 200 according to the above-described embodiment. FIG. 14 is a graph of a flow rate waveform with a vertical axis representing a flow rate of air and a horizontal axis representing time. Note that the block diagram of FIG. 13 is a block diagram illustrating a flow of signal processing in the physical quantity detection device 100 and the signal processing device 200 according to this modified example, which corresponds to the block diagram of FIG. 9 of the above-described embodiment. In addition, the graph of FIG. 14 corresponds to the graph of FIG. 11 of the above-described embodiment.

In the physical quantity detection device 100 and the signal processing device 200 according to this modified example, the direction determination unit 210 stores a determination reference value Koff of the flow rate Fd based on the detection signal DS of the thermal flow sensor 151 (block B0) as illustrated in FIG. 13. As illustrated in FIG. 14, the determination reference value Koff is set based on the value of the detection signal DS in such a way that, for example, the flow rate Fd based on the detection signal DS when the true air flow rate Ft during pulsation of the air in which the flow of the air is alternately switched between the forward flow and the reverse flow becomes 0 is offset to 0. The direction determination unit 210 determines the forward flow or the reverse flow of the air based on the flow rate Fd based on the detection signal DS and the determination reference value Koff. That is, for example, the direction determination unit 210 determines that the flow of the air is the forward flow if the flow rate Fd based on the detection signal DS is equal to or more than the determination reference value Koff, and determines that the flow of the air is the reverse flow if the flow rate Fd based on the detection signal DS is less than the determination reference value Koff.

With the physical quantity detection device 100 and the signal processing device 200 according to this modified example, for example, as illustrated in FIG. 14, even when attenuation occurs in the flow rate waveform Fd based on the detection signal DS of the thermal flow sensor 151, it is possible to detect the reverse flow region of the true flow rate waveform Ft based on the determination reference value Koff.

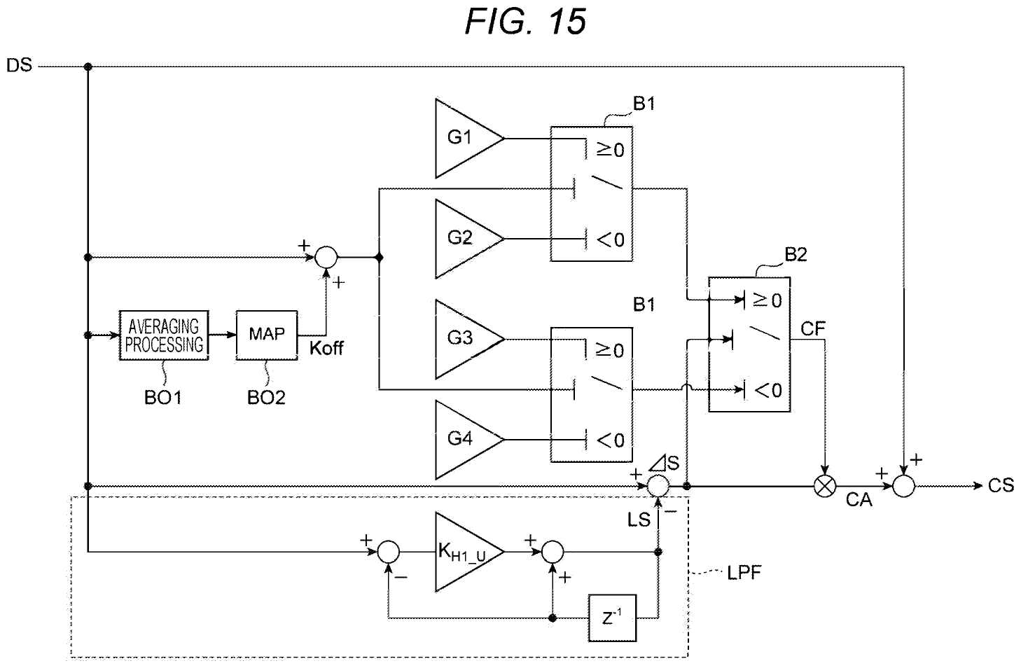

FIG. 15 is a block diagram illustrating a third modified example of the physical quantity detection device 100 and the signal processing device 200 according to the above-described embodiment. In this modified example, the determination reference value Koff of the above-described second modified example is determined according to the flow rate of the air based on the detection signal DS of the thermal flow sensor 151. That is, in this modified example, the direction determination unit 210 executes, for example, averaging processing (block B01) on the detection signal DS. Here, the direction determination unit 210 stores, for example, a map defining a relationship between the flow rate based on the detection signal DS and the determination reference value Koff. For example, by using the map, the direction determination unit 210 outputs the determination reference value Koff according to the flow rate based on the detection signal DS obtained in the averaging processing (block B01) (block B02).

With the physical quantity detection device 100 and the signal processing device 200 according to the embodiment of this modified example, not only the same effects as in the second modified example can be obtained, but also the determination reference value Koff can be set according to the state of the air flow that changes according to the flow rate of the air as described above.

Although the embodiment of the signal processing device according to the present disclosure has been described in detail with reference to the drawings, the specific configuration is not limited to the embodiment, and design changes and the like without departing from the gist of the present disclosure are included in the present disclosure.

### REFERENCE SIGNS LIST

2 measurement target gas (air)
22 main passage
100 physical quantity detection device
114 inlet
116 outlet
130 sub-passage
131 inlet-side passage
132 outlet-side passage
151 thermal flow sensor
151a temperature detection portion
151b heating portion
200 signal processing device
210 direction determination unit
220 increase/decrease determination unit
230 correction factor storage unit
240 correction factor selection unit
250 signal correction unit
CF correction factor
Ft true flow rate
DS detection signal
G1 first factor
G2 second factor
G3 third factor
G4 fourth factor
Koff determination reference value

1. A physical quantity detection device comprising:
a thermal flow sensor that is configured to detect a forward flow and a reverse flow of air; and
a signal processing device that processes a detection signal of the thermal flow sensor, wherein
the signal processing device includes:
a direction determination unit that determines the forward flow or the reverse flow of the air based on the detection signal;
an increase/decrease determination unit that determines an increase or decrease in flow rate of the air based on the detection signal;
a correction factor storage unit that stores a first factor, a second factor, a third factor, and a fourth factor used for correction of the detection signal;
a correction factor selection unit that selects, as a correction factor, the first factor, the second factor, the third factor, or the fourth factor based on determination results of the direction determination unit and the increase/decrease determination unit; and
a signal correction unit that corrects the detection signal by using the correction factor, and
the correction factor selection unit selects the first factor in a case of the forward flow and the increase in flow rate, selects the second factor in a case of the reverse flow and the increase in flow rate, selects the third factor in a case of the forward flow and the decrease in flow rate, and selects the fourth factor in a case of the reverse flow and the decrease in flow rate.

2. The physical quantity detection device according to claim 1, further comprising a sub-passage in which the thermal flow sensor is disposed, wherein
the sub-passage includes an inlet for taking in the forward flow of the air from a main passage in which the physical quantity detection device is installed, an outlet for discharging the air taken in from the inlet to the main passage, an inlet-side passage between the inlet and the thermal flow sensor, and an outlet-side passage between the thermal flow sensor and the outlet, and
the inlet-side passage and the outlet-side passage have different shapes.

3. The physical quantity detection device according to claim 1, wherein the thermal flow sensor includes two temperature detection portions arranged at an interval in a flow direction of the air, and a heating portion disposed between the two temperature detection portions.

4. The physical quantity detection device according to claim 1, wherein at least one of the first factor, the second factor, the third factor, and the fourth factor is determined according to the flow rate of the air based on the detection signal.

5. The physical quantity detection device according to claim 1, wherein the direction determination unit stores a determination reference value based on a value of the detection signal when a true flow rate of the air during pulsation of the air in which a flow of the air is alternately switched between the forward flow and the reverse flow becomes 0, and determines the forward flow or the reverse flow based on the detection signal and the determination reference value.

6. The physical quantity detection device according to claim 5, wherein the determination reference value is determined according to the flow rate of the air based on the detection signal.

7. The physical quantity detection device according to claim 1, wherein
the signal processing device includes a memory that stores a previous value and a latest value of the detection signal, and
the signal correction unit corrects the latest value by using a differential value of the detection signal based on a difference between the previous value and the latest value.

8. A signal processing device that processes a detection signal of a thermal flow sensor configured to detect a forward flow and a reverse flow of air, the signal processing device comprising:
a direction determination unit that determines the forward flow or the reverse flow of the air based on the detection signal;
an increase/decrease determination unit that determines an increase or decrease in flow rate of the air based on the detection signal;
a correction factor storage unit that stores a first factor, a second factor, a third factor, and a fourth factor used for correction of the detection signal;
a correction factor selection unit that selects, as a correction factor, the first factor, the second factor, the third factor, or the fourth factor based on determination results of the direction determination unit and the increase/decrease determination unit; and
a signal correction unit that corrects the detection signal by using the correction factor, wherein
the correction factor selection unit selects the first factor in a case of the forward flow and the increase in flow rate, selects the second factor in a case of the reverse flow and the increase in flow rate, selects the third factor in a case of the forward flow and the decrease in flow rate, and selects the fourth factor in a case of the reverse flow and the decrease in flow rate.

9. A signal processing method for processing a detection signal of a thermal flow sensor configured to detect a forward flow and a reverse flow of air, the signal processing method comprising:
determining the forward flow or the reverse flow of the air based on the detection signal;
determining an increase or decrease in flow rate of the air based on the detection signal;
selecting a first factor, a second factor, a third factor, or a fourth factor as a correction factor based on a determination result indicating the forward flow or the reverse flow and a determination result indicating the increase or decrease in flow rate; and
correcting the detection signal by using the correction factor, wherein
in the selecting of the correction factor, the first factor is selected in a case of the forward flow and the increase in flow rate, the second factor is selected in a case of the reverse flow and the increase in flow rate, the third factor is selected in a case of the forward flow and the decrease in flow rate decrease, and the fourth factor is selected in a case of the reverse flow and the decrease in flow rate.
